(19) United States
(12) Patent Application Publication
(10) Pub. No.: US 2006/0245665 A1
(43) Pub. Date: Nov. 2, 2006

(54) Method to detect previous sharpening of an image to preclude oversharpening

(76) Inventors: Je-Ho Lee, San Diego, CA (US); Jay S. Gondek, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,826

(22) Filed: Apr. 29, 2005

(51) Int. Cl. G06K 9/40

(52) U.S. Cl. 382/266

(57) ABSTRACT

Disclosed are methods of processing digital images to detect previous sharpening of the images by sequentially examining characteristics of individual pixels within the image and the neighborhood of pixels immediately surrounding the individual pixels. Detection of previous sharpening allows detrimental oversharpening to be avoided. Also disclosed are methods of determining whether a digital image has been previously sharped and, based upon that determination, selectively sharpening the image.

### TECHNICAL FIELD

The present disclosure relates generally to methods of digital image processing.

### BACKGROUND

Digital imaging is well know in the art. Digital images are composed of an array of individual pixel elements, with each pixel representing a single element of the image. Digital images may originate in digital cameras, scanners, or other image processing equipment.

The visual appearance of a digital image may typically be significantly improved by emphasizing its high frequency content to enhance the edge and detail information. Invariably a properly-sharpened digital image is subjectively preferred to an unsharpened image, and is perceived as more “focused” and having more “detail”. If the image is sharpened too much, however, the image quality is subjectively viewed as having been degraded.

Oversharpening of an image can result from the inadvertent repeated application of common sharpening algorithms. In general, traditional sharpening algorithms, including traditional unsharp masking and adaptive non-linear sharpening methods, do not converge to an appropriate sharpness level with repeated applications; instead, the application of the algorithms to already sharpened images cause the images to go past “optimal” sharpness and develop visible artifacts.

Between “capture” and “render” (e.g., printing) of a digital image, the image may be subjected to multiple processing steps which may include sharpening. For example, a person may take a picture with a digital camera. This person emails the image to a friend, and the friend prints the picture out on an inkjet printer. Many digital cameras and printers have embedded sharpening features in them. If both the person taking the picture and the person printing the picture have enabled the sharpening features on their devices, the printout may look poor due to oversharpening.

Sharpening is generally applied to images from digital cameras and scanners to compensate for diffusion of the images during capture. Digital cameras and scanners typically apply an “anti-aliasing” filter to images. The anti-aliasing filter is utilized to help eliminate visible artifacts such as moire patterns which are a consequence of the sampled, rather than continuous, nature of digital images. Since moire patterns tend to be perceived as highly objectionable by camera users, camera and scanner manufacturers are inclined to sufficiently diffuse images such that moire patterns are effectively eliminated. The images then typically require sharpening to be acceptable to the camera user.

Typically, image processing equipment and software is not able to ascertain the past history of an image to determine whether it has previously been sharpened. One technique which is sometimes utilized to help track information about digital images is the use of “header tags” with the image files. A common type of header is the EXIF (“Exchangeable Image File” or “Exchangeable Image Format”) header. EXIF is a standard for storing information created by JEIDA (Japan Electronic Industry Development Association) to encourage interoperability between imaging devices. EXIF information may, for example, be included in the headers of “jpeg” files created by a digital camera to record camera settings such as image size, aperture and shutterspeed.

In theory, diligent use of the EXIF format could help preclude oversharpening. However, there are some significant shortcomings with using EXIF tag information in this manner. First, the use of EXIF tags to preclude oversharpening would require the standardization of tag information, which currently varies between manufacturers. Moreover, one cannot guarantee that every digital image has an EXIF tag. Also, the EXIF tag could most likely only indicate whether the image has been sharpened or not, and could not indicate whether the image has been optimally sharpened.

There is therefore a need for methods that efficiently and reliably detect whether an image has previously been sharpened, such that further detrimental sharpening can be avoided.

### SUMMARY

Exemplary embodiments of the invention include methods of processing digital images to detect previous sharpening of the images by sequentially examining characteristics of individual pixels within the image and the neighborhood of pixels immediately surrounding the individual pixels. Detection of previous sharpening allows detrimental oversharpening to be avoided. Further exemplary embodiments include determining whether a digital image has been previously sharped and, based upon that determination, selectively sharpening the image.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a generalized block diagram indicating how digital images may originate from a variety of sources, such that the previous processing done on the image may not be easily determinable;

FIGS. 2(a) and 2(b) indicate in general how “sharpening” an image typically affects edges within the image;

FIGS. 3(a), 3(b), and 3(c) indicate in general how successive sharpening of an image can result in “oversharpening” of edges within the image;

FIG. 4 is an overall block diagram of an embodiment of the invention;

FIG. 5 illustrates how, in an embodiment of the invention, a group of pixels within an image may be processed; and

FIG. 6 is a block diagram further illustrating an embodiment of the invention.

### DESCRIPTION OF EXEMPLARY EMBODIMENTS

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

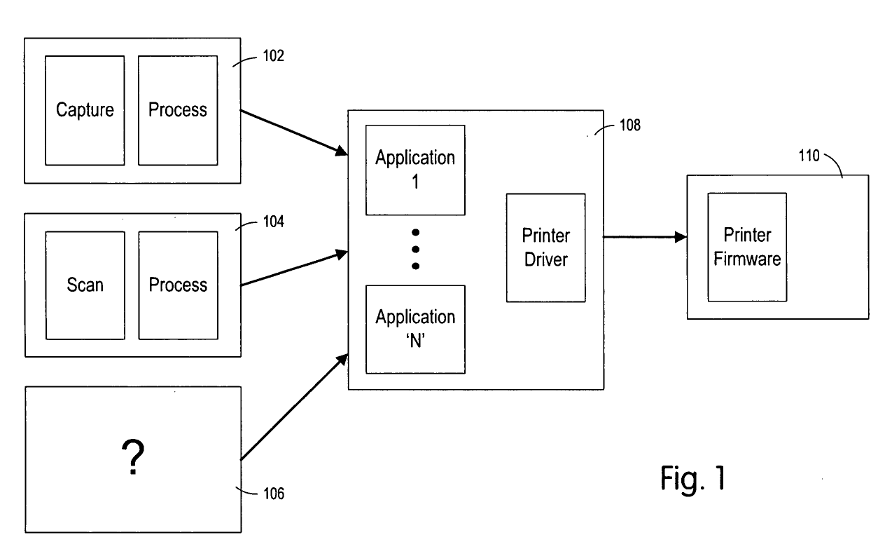

FIG. 1 is a generalized block diagram indicating the generalized “workflow” for digital images, from “capture” to “render” . Digital images may, for example, originate from a digital camera 102 or a scanner 104, which capture or scan an image. Typical cameras and scanners may also digitally process the “raw” images, such as by applying a low-pass filter to avoid moirépatterns; other processing may also be done, such as sharpening. The source of a particular digital image may be indeterminate 106, such that the “provenance” of the image is unknown, and there is therefore no straightforward means of knowing what processing has been applied to an image.

After capture, digital images often find their way to a processing system 106, such as a personal computer. In the processing system the images may be subject to modification or enhancement by multiple applications, such as image editing software. Many of these applications include functions for automatically enhancing images, which typically includes some degree of sharpening. When the image is prepared for printing, the print driver may also seek to optimize the image in some manner, as may the printer firmware in the printing device 110. Images may follow a circuitous path from capture to render, such as multiple printings and scannings, which can result in repeated “enhancement” of the image.

Since moderate sharpening is generally perceived as beneficial, sharpening is often routinely applied as an image is processed, which may result in an image being sharpened more than once. For example, an image may be sharpened at the point of capture; may then be sharpened again during image processing or editing; and may be also be sharpened in preparation for printing. Depending on the processing history of an image, there is the potential of inadvertent oversharpening. A printer driver, for example, may apply sharpening to images to optimize print quality; if the image has already been subjected to repeated sharpenings, the print driver sharpening may in fact degrade the image quality.

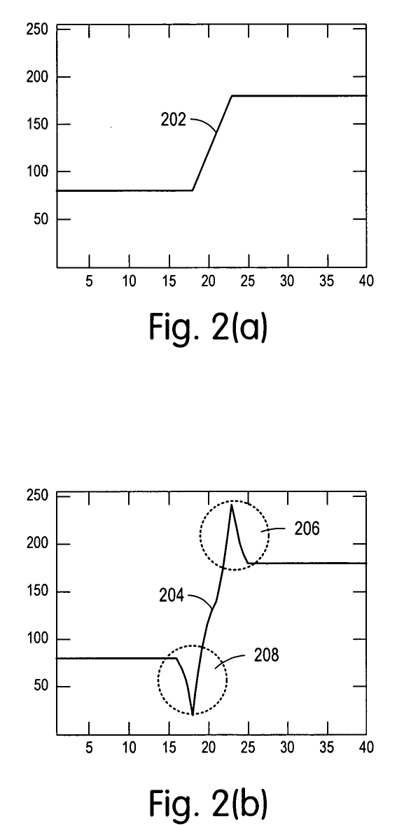

FIGS. 2(a) and 2(b) indicate in general how “sharpening” an image typically affects edges within the image. For simplicity of illustration, the figures show a one-dimensional representation of an image edge, such as would be observed in linearly scanning across an image. As shown in FIG. 2(a), the edge 202 represents a transition from a from an area of pixels having values of approximately 80, which may represent a “dark” area, to an area of pixels having values of approximately 180, which may represent a “light” area. Typically nearer the edge there are pixels with intermediate values, such that the transition is not abrupt.

FIG. 2(b) illustrates the effect of “sharpening” the edge of 2(a), such as, for example, by applying the commonly known technique of unsharp masking. As can be seen in FIG. 2(b), the sharpened edge 204 has areas of overshoot 206 and undershoot 208 around the two end points in the transition area. The magnitudes of these shootings are typically proportional to the edge slope and edge magnitude. In other words, these “shootings” can provide some important information regarding whether or not the image has been sharpened usual typical sharpening techniques, as discussed below.

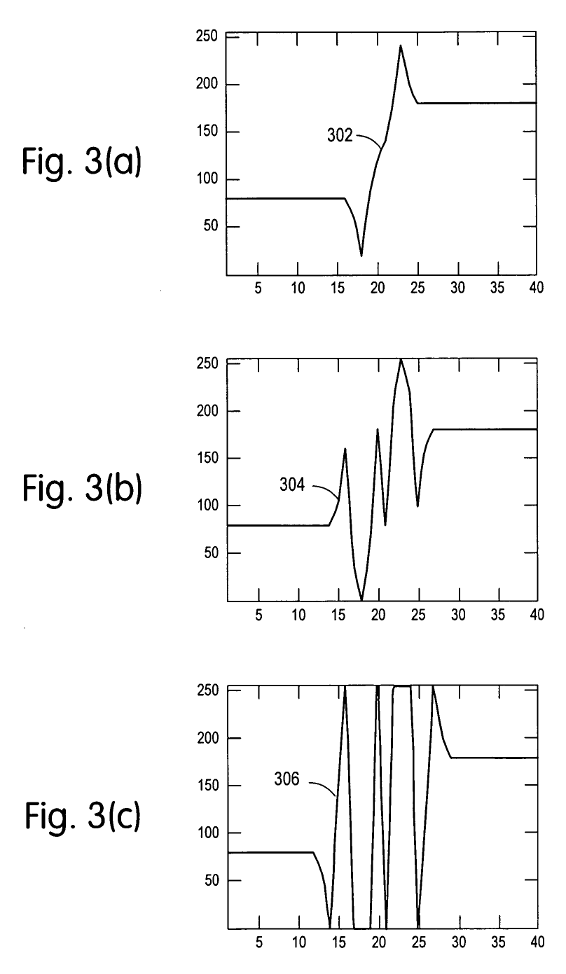

FIG. 3 shows the effects of “oversharpening” an image, such as may occur when common sharpening techniques are repeatedly applied to an image. FIG. 3(a) represents an edge 302 that has been sharpened once; FIG. 3(b) represents an edge 304 that has been sharpened twice; and FIG. 3(c) represents an edge 306 that has been sharpened three times. As the image is repeatedly sharpened, the original shootings (undershooting and overshooting) typically break into more complex regions of overshoot and undershoot. In certain situations, it can be become difficult to distinguish low-amplitude “real” edges from small “shootings”, which are by-products of sharpening (i.e., artificial edges).

Also, due to the limited quantization level of digital images (from 0 to 255 for typical 8-bit images), the sharpening does not generate any shootings around pixels which already have either maximum or minimum grayscale values. At this point, the pixel values of neighbors of these extreme points become close to those of extreme pixels, which in turn create multiple abrupt edges as illustrated in FIG. 3(c). By subjective evaluation of images, it has been determined that the situation illustrated in FIG. 3(c) is easily perceived as “oversharpened” to most observers.

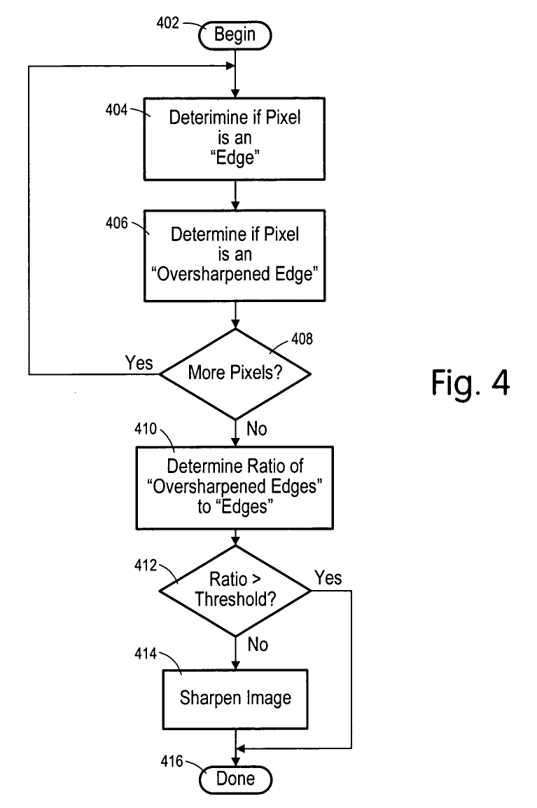

Embodiments of the invention thus contemplate detecting oversharpened images, such that additional detrimental sharpening can then be avoided. FIG. 4 depicts in general form exemplary embodiments of the invention. The exemplary methods begin 402 by sequentially processing substantially all pixels of an image to determine both whether a pixel is part of an “edge” 404, and whether a pixel is part of an “oversharpened edge” 406. Running counts of “edge”pixels and “oversharpened edge” pixels are maintained until substantially the entire image has been process 408. A ratio of “oversharpened edges” to “edges” is then determined 410, and, if the ratio is above a certain threshold 412, the image may be deemed already sharpened, and therefore additional sharpening is not beneficial. If the ratio is below the threshold, the image may safely be sharpened 414, and the exemplary methods end.

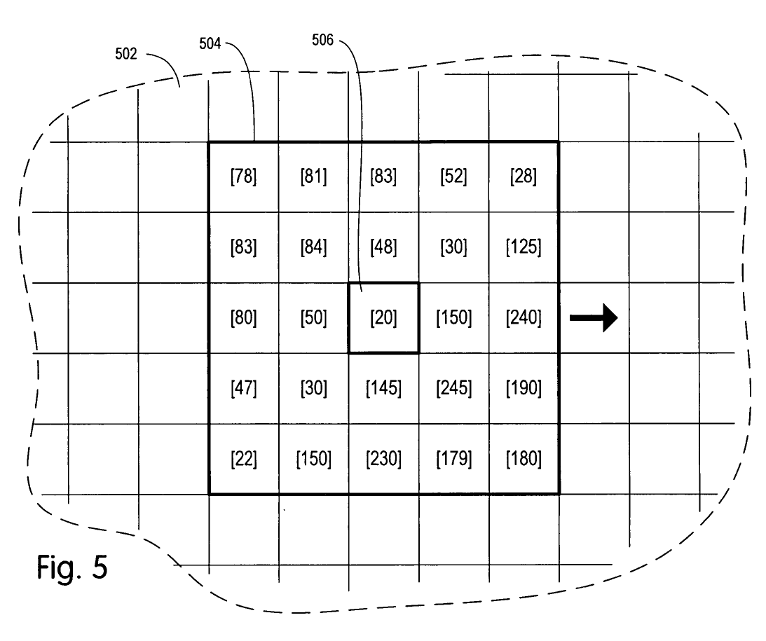

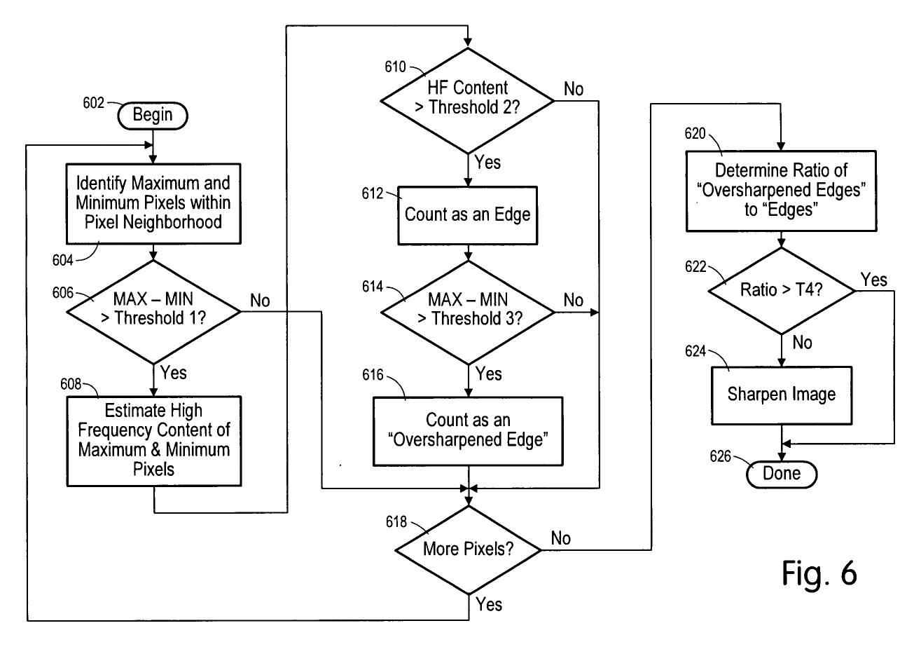

FIGS. 5 and 6 depict in additional detail how pixels in an image may be processed to determine whether they are part of an “edge” or an “oversharpened edge” according to embodiments of the invention. As seen in FIG. 5, the image consists of an array of pixels 502 in a grid of rows and columns; each pixel having a numeric value. A typical “selected” pixel 506 is thus surrounded by a “neighborhood” 504 of nearby pixels, here shown as a five-by-five grid. The values of the pixels within this five-by-five grid are used to determine if a pixel is part of an edge or oversharpened edge (although a five-by-five grid is used to illustrate the invention, different size “neighborhoods” may also be employed, as will be apparent to one skilled in the art).

As shown in FIG. 6, two criteria 606, 610 are used to determine if a selected pixel is part of an edge in the exemplary embodiment, and a then a third criteria 614 is used to determine whether the selected pixel is part of an “oversharpened edge”.

According to the exemplary embodiment, a selected pixel is determined to be an edge pixel if the range of values within the local pixel neighborhood exceeds a first threshold, and if the high frequency content of the neighborhood exceeds a second threshold. After the exemplary method begins 602, pixels of the image are processed sequentially. First, the maximum and minimum values of pixels within the local five-by-five pixel “neighborhood” are determined 604. Typically, a function commonly known as “MinMax” in many common programming languages is used. Then, the center, or selected, pixel within the local five-by-five window is examined if its value is maximum or minimum within the window. If the value is neither maximum nor minimum, the selected pixel is deemed to be neither an “edge pixel” nor an “oversharpened edge” pixel, and the exemplary method proceeds to the next pixel. In the exemplary pixel neighborhood of FIG. 5, the value of the selected pixel is 20, and hence it is the local minimum; and the local maximum pixel value is 245. The minimum value is subtracted from the maximum value, and compared to a first threshold. If the difference between the maximum and minimum does not exceed the threshold, the selected pixel is deemed to be neither an “edge pixel” nor an “oversharpened edge” pixel, and the exemplary method proceeds to the next pixel. If the difference exceeds the threshold, the high frequency content of the pixel neighborhood is estimated 608.

In embodiments of the invention, the high frequency content of the selected pixel is determined 608 essentially by applying a high-pass filter to the pixel neighborhood. In one exemplary embodiment, the high-pass filter is achieved by subtracting a blur image, which may comprise averaging the values of the pixels in the neighborhood (in the example of FIG. 5, the blur image would consist of a five-by-five pixel array with all pixels having a value of 106); other filters may also be used, such as, by way of example but not of limitation, a Gaussian filter. One exemplary method of classifying the edge pixel then takes the absolute value of the filtered value of the selected pixel; the result is then compared to a second threshold. If the resulting value does not exceed the threshold, the selected pixel is deemed to be neither an “edge pixel” nor an “oversharpened edge” pixel, and the exemplary method proceeds to the next pixel. If the difference exceeds the threshold, the pixel is deemed an “edge pixel” (the edge pixel count is incremented), and a determination 614 is made whether the selected pixel is also an oversharpened pixel.

Other methods of estimating the high frequency content of the pixel neighborhood will be apparent to those skilled in the art, and those methods may alternatively be used by embodiments of the invention.

In some embodiments of the invention, the determination 614 of whether a selected pixel is “oversharpened” comprises comparing the difference between the previously-determined minimum and maximum values of the pixel neighborhood to a third threshold, which is greater than the first threshold, above. If the third threshold is exceeded, the pixel is deemed an “oversharpened edge” (the oversharpened edge pixel count is incremented). The method then determines if there are more pixels in image to processed 618, and if yes, repeats the process by advancing to the next pixel (and advancing the “pixel neighborhood”).

Once substantially all pixels of the image have been processed, the ratio of “oversharpened edges” to “edges” is determined 620 by dividing the “oversharpened edge count” by the “edge count”. If the ratio exceeds a fourth threshold 622, the image is deemed to be sharpened such that it would not benefit from additional sharpening, and the exemplary method ends. If the threshold is not exceeded, the image may be beneficially sharpened 624, and the method ends 626.

Since the subjective perception of image quality may vary depending on many different factors, such as, for example, the type of image output device and the final image resolution, the four thresholds may be empirically determined to provide the best results in a particular situation. When used in a print driver or printer firmware, for example, the four thresholds may be selected to provide the best image quality for particular print modes.

The above descriptions have assumed a single numerical value for a pixel, such as would be the case in a grayscale image. For color images, image pixel data may be represented in a variety of formats, such as, for example, separate “channels” for three primary colors, such as red, green, and blue; or alternatively channels for luminance and chrominance. The exemplary methods may be applied to color images by separately processing each color plane, or processing only a luminance plane. Conversion between different representations of color image data are well understood, and it will be apparent to those skilled in the art that the exemplary methods may be adapted to operate with different representations of color image data.

Embodiments of the sharpening detection algorithm have been demonstrated to work with other images sharpened using a wide variety of sharpening techniques, including morphology-based nonlinear sharpening algorithms, which have been shown not to generate “shootings”. Even though the above exemplary algorithm is described as deferring sharpening until a determination is made for the entire image, embodiments of the algorithm may equally be applied to sharpening the image on a pixel-by-pixel basis, at the expense of a slightly lower accuracy. For example, all pixels may be sharpened using a technique such as unsharp masking, except those pixels which are determined to be “oversharpened” according to the algorithm, for which sharpening may be bypassed.

While the exemplary methods describe sequentially analyzing substantially all of the pixels of an image, it will be understood by those skilled in the art that the exemplary methods may be applied to only a portion of an image. A determination of whether the image has previously been sharpened may also be based on examining only a subset of multiple pixels within an image. Further, it may be recognized that any boundary conditions, such as those at image edges, are well within the ability of one skilled in the art to define.

The methods of the invention can be implemented by computer-executable instructions, such as those of one or more computer programs, and stored on a computer-readable medium. The computer-readable medium may be volatile or non-volatile memory, a magnetic, optical, and/or solid state memory, and so on.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

What is claimed is:

1. A method of detecting the previous sharpening of a digital image, comprising:
for multiple selected pixels in the image,
determining if the selected pixel constitutes an edge pixel; and then
determining if the selected pixel constitutes an oversharpened edge pixel;
determining a ratio of oversharpened edge pixels to edge pixels for the image; and
if the ratio does not exceeds a ratio threshold, designating the image as not previously sharpened.

2. The method of detecting the previous sharpening of a digital image of claim 1, wherein the step of determining if the selected pixel constitutes an edge pixel and if the selected pixel constitutes an oversharpened edge pixel further comprises examining characteristics of pixels within a neighborhood of pixels surrounding the selected pixel.

3. The method of detecting the previous sharpening of a digital image of claim 2, wherein the neighborhood of pixels surrounding the selected pixel comprises a square grid of pixels centered on the selected pixel.

4. The method of detecting the previous sharpening of a digital image of claim 3, wherein the square grid of pixels is a five-by-five grid.

5. The method of detecting the previous sharpening of a digital image of claim 3, wherein determining if the selected pixel constitutes an edge pixel comprises:
identifying a maximum pixel value and a minimum pixel value within the neighborhood of pixels; and, if the selected pixel corresponds to the minimum or maximum pixel value,
determining a difference between the maximum pixel value and the minimum pixel value; and, if difference exceeds a first threshold,
detecting a high frequency content of the neighborhood of pixels, and if the high frequency contents exceeds a second threshold,
declaring the selected pixel to be an edge pixel.

6. The method of detecting the previous sharpening of a digital image of claim 5, wherein detecting the high frequency content of the neighborhood of pixels comprises applying a high-pass filter to the selected pixel.

7. The method of detecting the previous sharpening of a digital image of claim 6, wherein detecting the high frequency content of the neighborhood of pixels further comprises:
determining the absolute value of the filtered selected pixel; and
comparing the absolute value of the difference to a second threshold.

8. The method of detecting the previous sharpening of a digital image of claim 5, wherein determining if the selected pixel constitutes an oversharpened edge pixel comprises:
comparing the difference between the maximum pixel value and the minimum pixel value to a third threshold, the third threshold greater than the first threshold; and, if difference exceeds the third threshold, declaring the selected pixel to be an oversharpened edge pixel.

9. The method of detecting the previous sharpening of a digital image of claim 1, wherein the multiple selected pixels of the image comprise substantially all pixels of the image.

10. The method of detecting the previous sharpening of a digital image of claim 9, wherein the steps of
determining if the selected pixel constitutes an edge pixel; and
determining if the selected pixel constitutes an oversharpened edge pixel;
are performed sequentially on the substantially all pixels of the image.

11. The method of detecting the previous sharpening of a digital image of claim 1, further comprising:
if the image is designated as not previously sharpened, sharpening the image.

12. The method of detecting the previous sharpening of a digital image of claim 11, wherein the step of sharpening the image comprises sharpening the image using unsharp masking.

13. A method of sharpening a digital image while avoiding oversharpening, comprising:
for multiple selected pixels in the image,
determining if the selected pixel constitutes an edge pixel; and then
determining if the selected pixel constitutes an oversharpened edge pixel;
determining a ratio of oversharpened edge pixels to edge pixels for the image; and
if the ratio does not exceeds a ratio threshold, sharpening the image.

14. The method of sharpening a digital image while avoiding oversharpening of claim 13, wherein the step of determining if the selected pixel constitutes an edge pixel and if the selected pixel constitutes an oversharpened edge pixel further comprises examining characteristics of pixels within a neighborhood of pixels surrounding the selected pixel.

15. The method of sharpening a digital image while avoiding oversharpening of claim 14, wherein the neighborhood of pixels surrounding the selected pixel comprises a square grid of pixels centered on the selected pixel.

16. The method of sharpening a digital image while avoiding oversharpening of claim 15, wherein the square grid of pixels is a five-by-five grid.

17. The method of sharpening a digital image while avoiding oversharpening of claim 15, wherein determining if the selected pixel constitutes an edge pixel comprises:
identifying a maximum pixel value and a minimum pixel value within the neighborhood of pixels;
determining a difference between the maximum pixel value and the minimum pixel value; and, if difference exceeds a first threshold,
detecting a high frequency content of the neighborhood of pixels, and if the high frequency contents exceeds a second threshold,
declaring the selected pixel to be an edge pixel.

18. The method of detecting the previous sharpening of a digital image of claim 17, wherein detecting the high frequency content of the neighborhood of pixels comprises applying a high-pass filter to the selected pixel.

19. The method of detecting the previous sharpening of a digital image of claim 18, wherein detecting the high frequency content of the neighborhood of pixels further comprises:
determining the absolute value of the filtered selected pixel; and
comparing the absolute value of the difference to a second threshold.

20. The method of sharpening a digital image while avoiding oversharpening of claim 17, wherein determining if the selected pixel constitutes an oversharpened edge pixel comprises:
comparing the difference between the maximum pixel value and the minimum pixel value to a third threshold, the third threshold greater than the first threshold; and, if difference exceeds the third threshold, declaring the selected pixel to be an oversharpened edge pixel.

21. The method of sharpening a digital image while avoiding oversharpening of claim 13, wherein the multiple selected pixels of the image comprise substantially all pixels of the image.

22. The method of sharpening a digital image while avoiding oversharpening of claim 21, wherein the steps of
determining if the selected pixel constitutes an edge pixel; and
determining if the selected pixel constitutes an oversharpened edge pixel;
are performed sequentially on the substantially all pixels of the image.

23. A method of detecting the previous sharpening of a digital image, comprising:
for multiple selected pixels within the image
identifying minimum and maximum pixel values within a pixel neighborhood of the selected pixel;
determining if the range between the identified minimum and maximum values exceeds a first threshold; and, if yes estimating the high frequency content of the pixel neighborhood; and
determining if the estimated high frequency content exceeds a second threshold; and, if yes
counting the selected pixel as an edge pixel, and determining if the range between the identified minimum and maximum values exceeds a third threshold, the third threshold greater than the first threshold; and, if yes, counting the selected pixel as an oversharpened edge pixel;
determining a ratio of oversharpened edge pixels to edge pixels based on the countings;
comparing the ratio to a third threshold, and, if the threshold is exceeded, identifying the image as previously sharpened.

24. The method of sharpening a digital image while avoiding oversharpening of claim 23, wherein the neighborhood of pixels surrounding the selected pixel comprises a square grid of pixels centered on the selected pixel.

25. The method of sharpening a digital image while avoiding oversharpening of claim 24, wherein the square grid of pixels is a five-by-five grid.

26. The method of detecting the previous sharpening of a digital image of claim 23, wherein detecting the high frequency content of the neighborhood of pixels comprises applying a high-pass filter to the neighborhood of pixels.

27. The method of sharpening a digital image while avoiding oversharpening of claim 23, wherein the multiple selected pixels of the image comprise substantially all pixels of the image.
